(19) United States
(12) Patent Application Publication
(10) Pub. No.: US 2007/0005697 A1
(43) Pub. Date: Jan. 4, 2007

(54) Methods and apparatuses for detecting content corresponding to a collaboration session

(76) Inventors: Eric Yuan, San Jose, CA (US); David Knight, Belmont, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/323,256

(22) Filed: Dec. 29, 2005

Related U.S. Application Data
(60) Provisional application No. 60/695,716, filed on Jun. 29, 2005.

(51) Int. Cl. G06F 15/16

(52) U.S. Cl. 709/204

(57) ABSTRACT

In one embodiment, the systems and methods detect a data file wherein the data file includes archived content utilized during a collaboration session; select a portion of the archived content within the data file based on a search term; and identify additional content utilized during the collaboration session that is associated with the portion of the archived content.

### RELATED APPLICATION

The present invention is related to, and claims the benefit of U.S. Provisional Application No. 60/695,716, filed on Jun. 29, 2005 entitled “Methods and Apparatuses For Recording A Collaboration Session,” by Eric Yuan and David Knight.

### FIELD OF INVENTION

The present invention relates generally to detecting content and, more particularly, to detecting content corresponding to a collaboration session.

### BACKGROUND

There has been an increased use in collaboration sessions that are Internet or web-based to communicate with employees, vendors, and clients. During these collaboration sessions, information is typically exchanged between multiple participants. This exchanged information or content may include audio, graphical, and/or textual information.

### SUMMARY

In one embodiment, the systems and methods detect a data file wherein the data file includes archived content utilized during a collaboration session; select a portion of the archived content within the data file based on a search term; and identify additional content utilized during the collaboration session that is associated with the portion of the archived content.

### BRIEF DESCRIPTION OF THE DRAWINGS

The accompanying drawings, which are incorporated in and constitute a part of this specification, illustrate and explain one embodiment of the methods and apparatuses for detecting content corresponding to a collaboration session. In the drawings,

FIG. 1 is a diagram illustrating an environment within which the methods and apparatuses for detecting content corresponding to a collaboration session are implemented;

FIG. 2 is a simplified block diagram illustrating one embodiment in which the methods and apparatuses for detecting content corresponding to a collaboration session are implemented;

FIG. 3 is a simplified block diagram illustrating a system, consistent with one embodiment of the methods and apparatuses for detecting content corresponding to a collaboration session;

FIG. 4 is a flow diagram consistent with one embodiment of the methods and apparatuses for detecting content corresponding to a collaboration session;

FIGS. 5A, 5B, and 5C are flow diagrams consistent with one embodiment of the methods and apparatuses for detecting content corresponding to a collaboration session; and

FIG. 6 is a flow diagram consistent with one embodiment of the methods and apparatuses for detecting content corresponding to a collaboration session.

### DETAILED DESCRIPTION

The following detailed description of the methods and apparatuses for detecting content corresponding to a collaboration session refers to the accompanying drawings. The detailed description is not intended to limit the methods and apparatuses for detecting content corresponding to a collaboration session. Instead, the scope of the methods and apparatuses for detecting content corresponding to a collaboration session is defined by the appended claims and equivalents. Those skilled in the art will recognize that many other implementations are possible, consistent with the present invention.

References to a device include a device utilized by a user such as a desktop computer, a portable computer, a personal digital assistant, a video phone, a landline telephone, a cellular telephone, and a device capable of receiving/transmitting an electronic signal.

References to content include audio, video, graphical, and/or textual data.

References to a collaboration session include a plurality of devices that are configured to view content submitted by one of the devices.

References to a participant device include devices that are participating in the collaboration session.

References to a presenter device include a device that is participant and shares content shared with other participants.

References to an attendee device include a device that is a participant and receives content shared by another participant device. The attendees are capable of view content that is offered by the presenter device. In some instances, the attendee devices are capable of modifying the content shared by the presenter device.

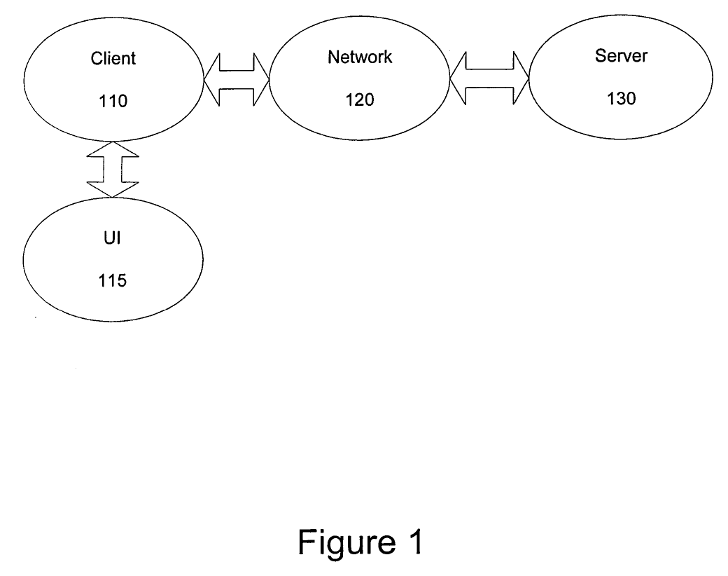

FIG. 1 is a diagram illustrating an environment within which the methods and apparatuses for detecting content corresponding to a collaboration session are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of detecting content corresponding to a collaboration session below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

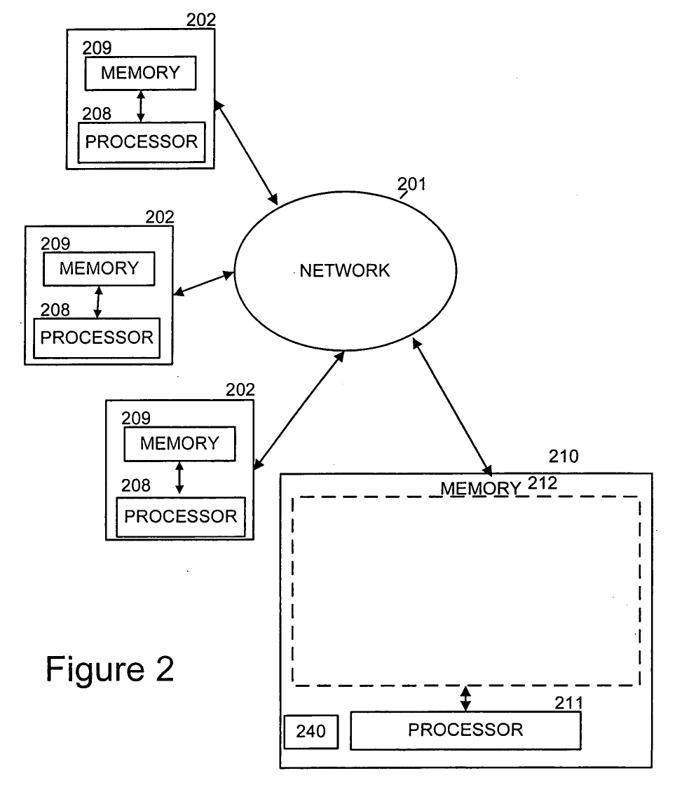

FIG. 2 is a simplified diagram illustrating an exemplary architecture in which the methods and apparatuses for detecting content corresponding to a collaboration session are implemented. The exemplary architecture includes a plurality of electronic devices 202, a server device 210, and a network 201 connecting electronic devices 202 to server 210 and each electronic device 202 to each other. The plurality of electronic devices 202 are each configured to include a computer-readable medium 209, such as random access memory, coupled to an electronic processor 208. Processor 208 executes program instructions stored in the computer-readable medium 209. In one embodiment, a unique user operates each electronic device 202 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 202 and the server 210 include instructions for a customized application for selectively sharing a portion of a display during a collaboration session. In one embodiment, the plurality of computer-readable media 209 and 212 contain, in part, the customized application. Additionally, the plurality of client devices 202 and the server 210 are configured to receive and transmit electronic messages for use with the customized application. Similarly, the network 210 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on detecting content corresponding to a collaboration session as determined using embodiments described below.

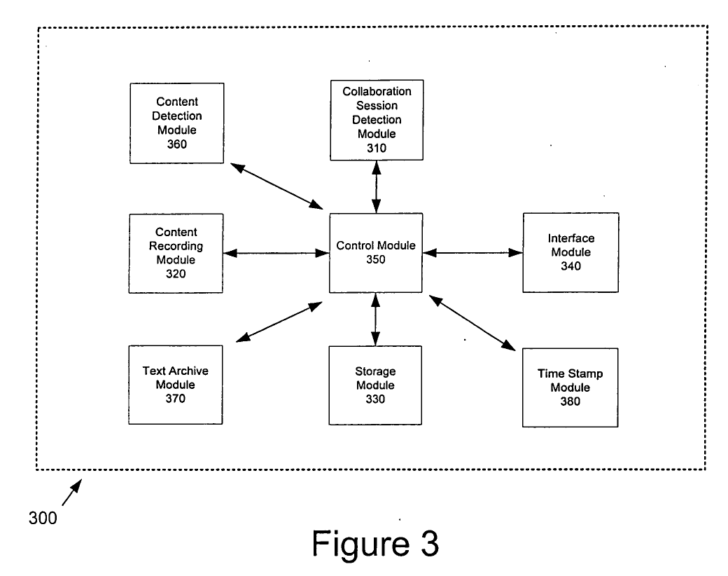

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a collaboration session detection module 310, a content recording module 320, a storage module 330, an interface module 340, a control module 350, a text extraction module 360, a text archive module 370, and a time stamp module 380.

In one embodiment, the control module 350 communicates with the collaboration session detection module 310, the content recording module 320, the storage module 330, the interface module 340, the text extraction module 360, the text archive module 370, and the time stamp module 380. In one embodiment, the control module 350 coordinates tasks, requests, and communications between the collaboration session detection module 310, the content recording module 320, the storage module 330, the interface module 340, the text extraction module 360, the text archive module 370, and the time stamp module 380.

In one embodiment, the collaboration detection module 310 detects a collaboration session between multiple participants. In one embodiment, the collaboration session includes sharing content among the participants through a phone line and/or through a display device. For example, voice and data content may be carried through the phone line and displayed through the display device such as a computer system, a cellular phone, a personal digital assistant, and the like.

Further, the content may include graphical and textual data through word processors, chat windows, documents, and the like.

In one embodiment, the content recording module 320 records the content that is exchanged during the collaboration session.

In one embodiment, the storage module 330 stores the content that is recorded within the content recording module 320. Further, the storage module 330 is also configured to store information corresponding to the participants of the collaboration session.

In one embodiment, the interface detection module 340 detects when the text messages are being transmitted from one of the devices participating in the collaboration session. In another embodiment, the interface detection module 340 monitors the voice transmissions originating from one of the devices participating in the collaboration session. In yet another embodiment, the interface detection module 340 detects any activity by one of the devices participating in the collaboration session.

In one embodiment, the interface module 340 receives a signal from one of the electronic devices 110. In one embodiment, the electronic devices 110 are participating in a collaboration session. In another embodiment, the interface module 340 delivers a signal to one of the electronic devices 110.

In one embodiment, the content detection module 360 monitors the content that is exchanged between participants within the collaboration session.

In one embodiment, the content detection module 360 detects the different types of content that is exchanged during the collaboration session such as text messages through instant messaging, voice information, application sharing, and the like.

In one embodiment, the text archive module 370 receives the text messages that are transmitted among the participants during the collaboration session and saves them within the storage module 330. In one embodiment, the text archive module 370 formats the individual text messages into a single file and denotes the author of each text message.

In another embodiment, the text archive module 370 receives voice data streams and converts these voice data streams into a textual representation. Further, the text archive module 370 formats the individual textual representations into a single file and denotes the author of each textual representation.

In one embodiment, the time stamp module 380 assigns a time to discrete portions of the content exchanged among the participants during the collaboration session. For example, when the content is text messaging through instant messaging, then the time stamp module 380 assigns a time stamp to each text message transmitted based on the time of transmission. In another example, when content is streamed during the collaboration session, the time stamp module 380 assigns a time stamp to a portion of the streamed content at a predetermined frequency.

In one embodiment, the time stamp corresponds to an actual time of day. In another embodiment, the time stamp corresponds to a time that the collaboration session was initiated.

The system 300 in FIG. 3 is shown for exemplary purposes and is merely one embodiment of the methods and apparatuses for detecting content corresponding to a collaboration session. Additional modules may be added to the system 300 without departing from the scope of the methods and apparatuses for detecting content corresponding to a collaboration session. Similarly, modules may be combined or deleted without departing from the scope of the methods and apparatuses for detecting content corresponding to a collaboration session.

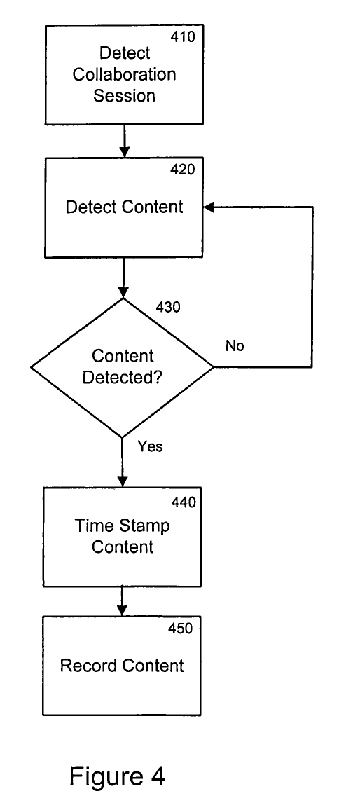

The flow diagrams as depicted in FIGS. 4, 5A, 5B, 5C, and 6 are one embodiment of the methods and apparatuses for detecting content corresponding to a collaboration session. The blocks within the flow diagrams can be performed in a different sequence without departing from the spirit of the methods and apparatuses for detecting content corresponding to a collaboration session. Further, blocks can be deleted, added, or combined without departing from the spirit of the methods and apparatuses for detecting content corresponding to a collaboration session.

The flow diagram in FIG. 4 illustrates detecting content corresponding to a collaboration session according to one embodiment of the invention.

In Block 410, a collaboration session is detected. In one embodiment, the collaboration session is detected when an attendee device initiates the session. In another embodiment, the collaboration session is detected when an invitee attends the collaboration session. In one embodiment, the collaboration session is detected by the collaboration session detection module 310.

In Block 420, content that is exchanged during the collaboration session is detected. In one embodiment, the content is detected through the content detection module 360. In one embodiment, the content includes documents, applications, voice data, audio data, textual data, graphical data, and the like.

In Block 430, if the content is not detected, then detection continues in the Block 420.

In Block 430, if the content is detected, then the content is time stamped in the Block 440. In one embodiment, the time stamp is applied to the content in the time stamp module 380. In one embodiment, the time stamp indicates a temporal relationship between the content and the collaboration session. For example, if the content is detected towards the beginning of the collaboration session, then the time stamp associated with this content represents a time period towards the beginning of the collaboration session.

In Block 450, the content is recorded with the associated time stamp. In one embodiment, the content recording module 320 records the content and the associated time stamp into the storage module 330.

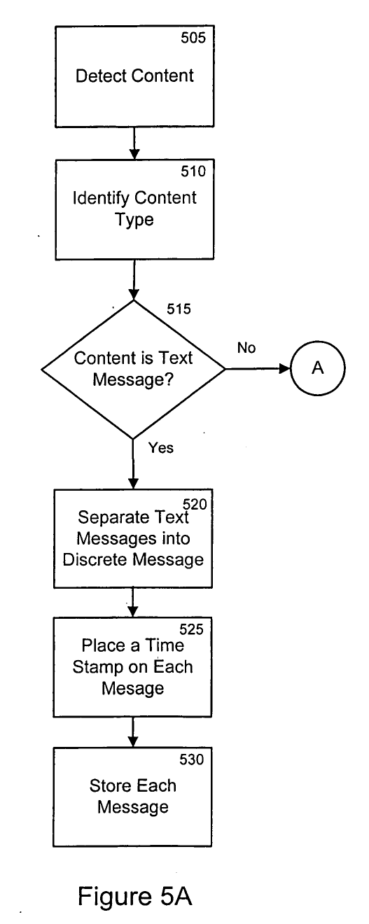

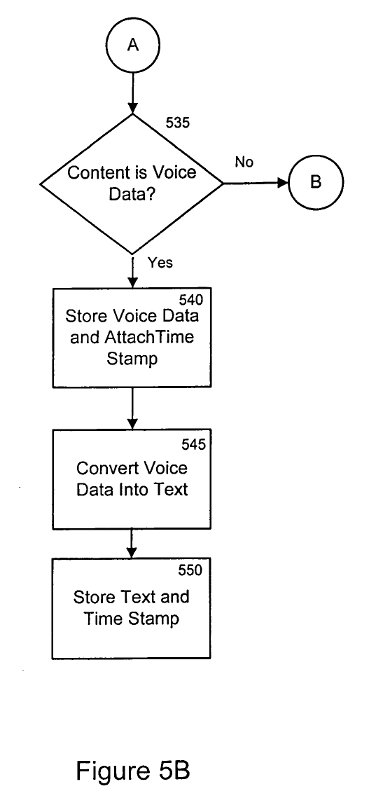

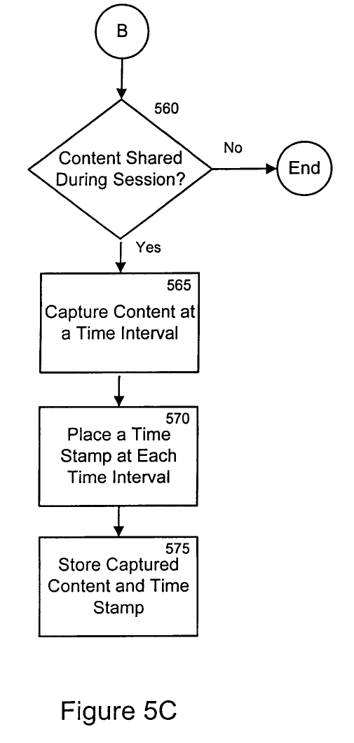

The flow diagram in FIG. 5A illustrates a method for recording content shared during collaboration session according to one embodiment of the invention.

In Block 505, content that is exchanged during the collaboration session is detected. In one embodiment, the content is detected through the content detection module 360. In one embodiment, the content includes documents, applications, voice data, audio data, textual data, graphical data, and the like.

In Block 510, the content identified in the Block 505 is analyzed to determine the type of the content. For example, the content types include documents, applications, voice data, text messages, and the like.

In Block 515, if the content is considered a text message, then the content is further processed in Block 520. If the content is not considered a text message, then the content is further processed in Block 535 (FIG. 5B). In one embodiment, the text message utilizes a SMS format. In another embodiment, the text message is provided by a service known as “Instant Messaging”. In yet another embodiment, the text messages are messages containing text and other content in real time from a participant to another participant of the collaboration session.

In the Block 520, in the event that there are multiple text messages, each text message is separated into discrete messages. For example, there can be multiple text messages sent by different or common participants of the collaboration session.

In Block 525, a time stamp is associated with each text message and is utilized to determine when the text message was sent relative to the collaboration session. For example, the time stamp may indicate an actual time of day. In another example, the time stamp may indicate a time count that is relative to the initiation of the collaboration session. In one embodiment, the time stamp module 380 forms the time stamp for each text message.

In Block 530, each of the text messages are stored and archived. In one embodiment, the text archive module 370 combines each of the separate text messages and incorporates the time stamp and the author with each text message. Further, the combined text messages are formatted as a text file in one embodiment.

In one embodiment, all the text messages transmitted within the collaboration session are combined within a single text file. In another embodiment, all the text messages transmitted within the collaboration session are stored in multiple text files.

In one embodiment, the text file is searchable for keywords, authors, time stamps, and the like.

In one embodiment, the text messages are stored in the storage module 330.

The flow diagram in FIG. 5B illustrates a method for recording content shared during collaboration session according to one embodiment of the invention.

In Block 535, if the content is considered voice data, then the content is further processed in Block 540. If the content is not considered a voice data, then the content is further processed in Block 560 (FIG. 5C). In one embodiment, the voice data is carried over a plain old telephone service (POTS). In another embodiment, the voice data is carried over voice over internet protocol (VoIP). In some instances, the voice data is transmitted among the participants of the collaboration session where the participants utilize a combination of POTS and VoIP services.

In Block 540, a time stamp is periodically attached to the voice data throughout the stream of voice data. In one embodiment, the frequency of the time stamp being attached to the voice data is selectable. For example, the frequency of the time stamp is selected as every second, every 10 seconds, every minute, and the like. In one embodiment, the time stamp is correlated to the timing of the collaboration session. For example, in one embodiment, the time stamp indicates an actual time of day. In another embodiment, the time stamp is relative to the initiation of the collaboration session.

In one embodiment, the voice data and the time stamp(s) are stored within the storage module 330.

In Block 545, the voice data is converted into text data. For example, the voice data stream is detected and converted into text data that represents the voice data stream. In one embodiment, after the conversion of the voice data into the text data, the time stamps are retained and associated with the corresponding text data.

In Block 550, the text data representing the voice data are stored and archived. Further, the time stamps are integrated and stored with the text data in one embodiment. In one embodiment, the text data are stored in the storage module 330.

The flow diagram in FIG. 5C illustrates a method for recording content shared during collaboration session according to one embodiment of the invention.

In Block 560, if the content is shared with one of the participants during the collaboration session, then the content is further processed in Block 565. In one embodiment, the content includes animations, video, documents, applications that are shared during the collaboration session.

In Block 565, the content is captured at a time interval. In one embodiment, the time interval is selected to adequately capture the content. For example, to adequately capture video, the periodic time interval is set to capture at 15 times per second. Further, to adequately capture static documents, the periodic time interval is set to capture at 1 time per second.

In Block 570, a time stamp is attached to the content at each time interval. In one embodiment, the time stamp is correlated to the timing of the collaboration session. For example, in one embodiment, the time stamp indicates an actual time of day. In another embodiment, the time stamp is relative to the initiation of the collaboration session.

In Block 550, the captured content and the associated time stamps are stored and archived. In one embodiment, the captured content and the associated time stamps are stored in the storage module 330.

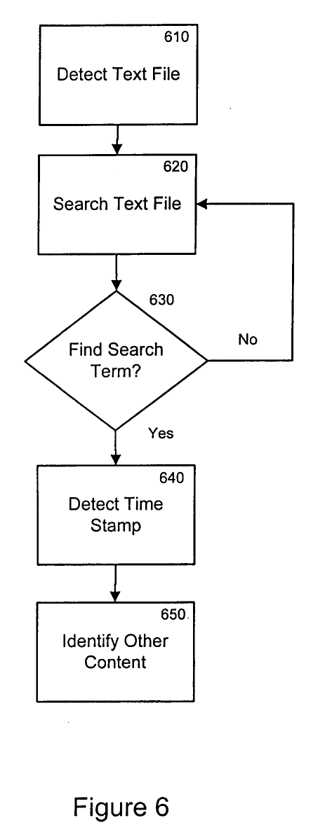

The flow diagram in FIG. 6 illustrates accessing content that was previously recorded during a collaboration session according to one embodiment of the invention.

In Block 610, a text file corresponding to a collaboration session is detected. In one embodiment, the text file represents text messages, voice data, documents, applications that were shared during the collaboration session. In another embodiment, the text file may correspond to multiple collaboration sessions.

In Block 620, a key search term is utilized to search the text file. For example, a search term may include “manager” when the collaboration session pertains to interfacing with customers and resolving customer service issues. By doing a search for the term “manager”, a user may be able to search instances during the collaboration session that one of the participants requested assistance from a manager in this example.

In another example, if the collaboration session include participation from a financial institution, key search terms that are searched may include buy, sell, transfer, deposit, withdraw, and the like. In this example, by searching for these terms, a user is capable of identifying instances within the collaboration session that may need further review.

In Block 630, if the searched term is not found, then additional search terms may be utilized in the Block 620.

If the search term is found, then the time stamp associated with the location of the search term within the text file detected in Block 640.

In Block 650, additional content that was shared during the collaboration session is also identified. For example, voice data identified in the Block 535 and shared content identified in the Block 560 that share the detected time stamp from the Block 640 are also identified.

In one embodiment, additional time stamps within a predetermined amount of time of the time stamp identified in the Block 640 are also identified. Further, shared content that correspond to these additional time stamps are also identified.

In use, if the collaboration session involves a financial institution, the shared content that occurs prior to and after the time stamp associated with a search term is identified. In this example, the shared content prior to and after the search term provides background and context to the specific search term found within the collaboration session. The actual number of time stamps that are identified in the Block 650 prior to and after the search term depends on the frequency of the time stamps.

Although the Blocks 610 and 620 utilize a text file, different types of files can be substituted in other embodiments. For example, a voice data file may be searched within the Block 620 for a key term. Further, once the key term is found within the voice data file, a corresponding time stamp is identified through the Block 540.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
detecting a data file that corresponds to content utilized during a collaboration session;
identifying a search term within the data file; and
identifying a first time stamp corresponding to a portion of the data file associated with the search term.

2. The method according to claim 1 further comprising searching the data file for the search term.

3. The method according to claim 1 wherein the data file includes textual data.

4. The method according to claim 1 wherein the data file includes audio data.

5. The method according to claim 1 further comprising identifying additional content exclusive of the data file corresponding with the first time stamp wherein the additional content is utilized during the collaboration session.

6. The method according to claim 5 wherein the additional content contains graphical data.

7. The method according to claim 5 wherein the additional content contains textual data.

8. The method according to claim 5 wherein the additional content contains audio data.

9. The method according to claim 1 further comprising identifying a second time stamp that is temporally adjacent to the first time stamp.

10. The method according to claim 9 further comprising identifying content associated with the second time stamp.

11. The method according to claim 9 wherein the second time stamp is within a predetermined amount of time of the first time stamp.

12. A method, comprising:
detecting a data file wherein the data file includes archived content utilized during a collaboration session;
selecting a portion of the archived content within the data file based on a search term; and
identifying additional content utilized during the collaboration session that is associated with the portion of the archived content.

13. The method according to claim 12 further comprising searching the data file for the portion of the archived content based on the search term.

14. The method according to claim 12 wherein the archived content is textual data.

15. The method according to claim 12 wherein the archived content is audio data.

16. The method according to claim 12 further comprising identifying a time stamp associated with the portion of the archived content.

17. The method according to claim 16 wherein the time stamp is associated with the additional content.

18. The method according to claim 12 wherein the additional content is graphical data.

19. A system comprising:
means for detecting a data file wherein the data file includes archived content utilized during a collaboration session;
means for selecting a portion of the archived content within the data file based on a search term; and
means for identifying additional content utilized during the collaboration session that is associated with the portion of the archived content.
